(19) United States
(12) Patent Application Publication
(10) Pub. No.: US 2024/0293913 A1
(43) Pub. Date: Sep. 5, 2024

(54) Sharpening Parameter And Determination System For A Lawn Mower Blade Sharpening And Task Robot

(71) Applicant: Brian F. Smith, Monkton, MD (US)

(72) Inventor: Brian F. Smith, Monkton, MD (US)

(21) Appl. No.: 18/591,463

(22) Filed: Feb. 29, 2024

Related U.S. Application Data
(60) Provisional application No. 63/449,177, filed on Mar. 1, 2023.

(51) Int. Cl. B24B 49/04; B24B 3/36

(52) U.S. Cl. CPC B24B 49/04; B24B 3/36

(57) ABSTRACT

Provided are systems and methods for controlling a blade sharpening and task robot. The system may include at least one processor configured to receive blade data associated with a blade of a lawn mower. The at least one processor may be configured to determine a task of a plurality of tasks associated with the blade of the lawn mower based on the blade data. The at least one processor may be configured to generate a message including data associated with the task. The at least one processor may be configured to send the message to a computing device, where the computing device is configured to display the message via a display of the computing device. The at least one processor may be configured to perform the task. The task may include sharpening the blade of the lawn mower and/or repairing the blade of the lawn mower.

### CROSS REFERENCE TO RELATED APPLICATION(S)

The present application claims the benefit of U.S. Provisional Patent Application No. 63/449,177 filed on Mar. 1, 2023, the disclosure of which is hereby incorporated by reference in its entirety.

### BACKGROUND

### 1. Technical Field

The present disclosure relates generally to a lawn mower blade sharpening and task robot, and in non-limiting embodiments, to systems and methods for controlling a blade sharpening and task robot.

### 2. Technical Considerations

Typically, methods for determining the sharpness of a lawn mower blade require a user to remove the blade from the lawn mower and measure a sharpness of the blade (e.g., a size of a cutting edge of the blade and/or a sharpness of the cutting edge of the blade). If the sharpness of the blade does not satisfy a threshold, then the user must alternate between sharpening the blade and measuring the sharpness of the blade to satisfy the threshold (e.g., determine an optimal sharpness). Such methods may be time consuming, cause blade degradation, and/or cause excess blade material to be removed from the blade.

### SUMMARY

In some non-limiting embodiments, provided is a system for controlling a blade sharpening and task robot. In some non-limiting embodiments, the system may include at least one processor. In some non-limiting embodiments, the at least one processor may be configured to receive blade data, the blade data associated with a blade of a lawn mower. In some non-limiting embodiments, the at least one processor may be configured to determine a task of a plurality of tasks associated with the blade of the lawn mower based on the blade data. In some non-limiting embodiments, the at least one processor may be configured to generate a message comprising data associated with the task of the plurality of tasks associated with the blade. In some non-limiting embodiments, the at least one processor may be configured to send the message comprising the data associated with the task of the plurality of tasks associated with the blade to at least one computing device. In some non-limiting embodiments, the at least one computing device may be configured to display the message via a display of the at least one computing device.

In some non-limiting embodiments, the at least one processor may be configured to determine sharpness of the blade using at least one of a pressure gauge, a sensor, a calibration device, a pneumatic device, a sonar pulse, and/or any combination thereof.

In some non-limiting embodiments, the at least one processor may be configured to determine whether the sharpness of the blade satisfies a threshold value.

In some non-limiting embodiments, the task of the plurality of tasks may include sharpening the blade, and based on determining that the sharpness of the blade satisfies the threshold value, the at least one processor may be configured to perform the task of the plurality of tasks associated with the blade.

In some non-limiting embodiments, the blade data may include a sharpness of the blade, and, when determining the task of a plurality of tasks associated with the blade based on the blade data, the at least one processor may be configured to determine the task of a plurality of tasks associated with the blade based on the sharpness of the blade.

In some non-limiting embodiments, the blade data may include a status of the blade, and where, when determining the task of a plurality of tasks associated with the blade based on the blade data, the at least one processor may be configured to determine whether the blade may be a defective blade based on the status of the blade. In some non-limiting embodiments, the at least one processor may be configured to determine the task of the plurality of tasks associated with the blade based on determining the blade is a defective blade.

In some non-limiting embodiments, the at least one computing device may be a robot, and the robot may be configured to perform the task of the plurality of tasks based on receiving the message comprising the data associated with the task of the plurality of tasks associated with the blade.

In some non-limiting embodiments, provided is a system for controlling a blade sharpening and task robot. In some non-limiting embodiments, the system may include at least one sensor, at least one task arm, and/or at least one processor. In some non-limiting embodiments, the at least one processor may be operatively connected to the at least one sensor and/or the at least one task arm. In some non-limiting embodiments, the at least one processor may be configured to determine blade data associated with a blade of a lawn mower based on a signal received from the at least one sensor. In some non-limiting embodiments, the at least one processor may be configured to determine a task of a plurality of tasks associated with the blade based on the blade data. In some non-limiting embodiments, the at least one processor may be configured to control the at least one task arm to perform the task of the plurality of tasks associated with the blade.

In some non-limiting embodiments, the at least one processor may be further configured to determine a sharpness of the blade based on a second signal received from the at least one sensor.

In some non-limiting embodiments, when controlling the at least one task arm to perform the task of the plurality of tasks associated with the blade, the at least one processor may be configured to determine whether the sharpness of the blade satisfies a threshold value. In some non-limiting embodiments, the at least one processor may control the at least one task arm to sharpen the blade of the lawn mower, based on determining that the sharpness of the blade satisfies the threshold value.

In some non-limiting embodiments, the at least one processor may be further configured to generate a message comprising data associated with the task of the plurality of tasks associated with the blade. In some non-limiting embodiments, the at least one processor may be configured to send the message comprising the data associated with the task of the plurality of tasks associated with the blade to at least one computing device, where the at least one computing device may be configured to display the message via a display of the at least one computing device.

In some non-limiting embodiments, the blade data may include a status of the blade, and, when determining the task of a plurality of tasks associated with the blade based on the blade data, the at least one processor may be configured to determine whether the blade may be a defective blade based on the status of the blade.

In some non-limiting embodiments, the at least one processor may be configured to control the at least one task arm to repair the blade based on determining the blade is a defective blade.

In some non-limiting embodiments, the at least one computing device may be a robot, and the robot may be configured to perform the task of the plurality of tasks based on receiving the message.

In some non-limiting embodiments, provided is a method for controlling a blade sharpening and task robot. In some non-limiting embodiments, the method may include receiving blade data associated with a blade of a lawn mower. In some non-limiting embodiments, the method may include determining a task of a plurality of tasks associated with the blade based on the blade data. In some non-limiting embodiments, the method may include generating a message comprising data associated with the task of the plurality of tasks associated with the blade. In some non-limiting embodiments, the method may include sending the message comprising the data associated with the task of the plurality of tasks associated with the blade to at least one computing device. In some non-limiting embodiments, the at least one computing device may be configured to display the message via a display of the at least one computing device.

In some non-limiting embodiments, the method may further include determining a sharpness of the blade using at least one of: a pressure gauge, a sensor, a calibration device, a pneumatic device, a sonar pulse, and/or any combination thereof.

In some non-limiting embodiments, the method may include determining whether the sharpness of the blade satisfies a threshold value.

In some non-limiting embodiments, the method may include performing the task of the plurality of tasks associated with the blade based on determining that the sharpness of the blade satisfies the threshold value, where the task of the plurality of tasks includes sharpening the blade.

In some non-limiting embodiments, the blade data may include a status of the blade. In some non-limiting embodiments, determining the task of a plurality of tasks associated with the blade based on the blade data may include determining that the blade is a defective blade based on the status of the blade.

In some non-limiting embodiments, the method may include performing the task of the plurality of tasks associated with the blade based on determining that the blade is a defective blade, where the task of the plurality of tasks includes repairing the blade.

Further non-limiting embodiments are set forth in the following numbered clauses:

Clause 1: A system, comprising: at least one processor configured to: receive blade data, the blade data associated with a blade of a lawn mower; determine a task of a plurality of tasks associated with the blade of the lawn mower based on the blade data; generate a message comprising data associated with the task of the plurality of tasks associated with the blade; and send the message comprising the data associated with the task of the plurality of tasks associated with the blade to at least one computing device, wherein the at least one computing device is configured to display the message via a display of the at least one computing device.

Clause 2: The system of clause 1, wherein the at least one processor is configured to: determine the threshold value using at least one of: a pressure gauge, a sensor, a calibration device, a pneumatic device, a sonar pulse, and/or any combination thereof.

Clause 3: The system of clause 1 or 2, wherein the at least one processor is further configured to: determine whether the sharpness of the blade satisfies a threshold value.

Clause 4: The system of any of clauses 1-3, wherein the task of the plurality of tasks comprises sharpening the blade, and wherein, based on determining that the sharpness of the blade satisfies the threshold value, the at least one processor is configured to: perform the task of the plurality of tasks associated with the blade.

Clause 5: The system of any of clauses 1-4, wherein the blade data comprises a sharpness of the blade, and wherein, when determining the task of a plurality of tasks associated with the blade based on the blade data, the at least one processor is configured to: determine the task of a plurality of tasks associated with the blade based on the sharpness of the blade.

Clause 6: The system of any of clauses 1-5, wherein the blade data comprises a status of the blade, and wherein, when determining the task of a plurality of tasks associated with the blade based on the blade data, the at least one processor is programmed to: determine whether the blade is a defective blade based on the status of the blade; and determine the task of the plurality of tasks associated with the blade based on determining the blade is a defective blade.

Clause 7: The system of any of clauses 1-6, wherein the at least one computing device is a robot, and wherein the robot is configured to perform the task of the plurality of tasks based on receiving the message comprising the data associated with the task of the plurality of tasks associated with the blade.

Clause 8: A system, comprising: at least one sensor; at least one task arm; and at least one processor operatively connected to the at least one sensor and the at least one task arm, the at least one processor configured to: determine blade data associated with a blade of a lawn mower based on a signal received from the at least one sensor; determine a task of a plurality of tasks associated with the blade based on the blade data; and control the at least one task arm to perform the task of the plurality of tasks associated with the blade.

Clause 9: The system of clause 8, wherein the at least one processor is further configured to: determine a sharpness of the blade based on a second signal received from the at least one sensor.

Clause 10: The system of clause 8 or 9, wherein, when controlling the at least one task arm to perform the task of the plurality of tasks associated with the blade, the at least one processor is configured to: determine whether the sharpness of the blade satisfies a threshold value; and control the at least one task arm to sharpen the blade of the lawn mower, based on determining that the sharpness of the blade satisfies the threshold value.

Clause 11: The system of any of clauses 8-10, wherein the at least one processor is further configured to: generate a message comprising data associated with the task of the plurality of tasks associated with the blade; and send the message comprising the data associated with the task of the plurality of tasks associated with the blade to at least one computing device, wherein the at least one computing device is configured to display the message via a display of the at least one computing device.

Clause 12: The system of any of clauses 8-11, wherein the blade data comprises a status of the blade, and wherein, when determining the task of a plurality of tasks associated with the blade based on the blade data, the at least one processor is configured to: determine whether the blade is a defective blade based on the status of the blade.

Clause 13: The system of any of clauses 8-12, wherein the at least one processor is configured to: control the at least one task arm to repair the blade based on determining the blade is a defective blade.

Clause 14: The system of any of clauses 8-13, wherein the at least one computing device is a robot, and wherein the robot is configured to perform the task of the plurality of tasks based on receiving the message.

Clause 15: A method, comprising: receiving, by at least one processor, blade data associated with a blade of a lawn mower; determining, by at least one processor, a task of a plurality of tasks associated with the blade based on the blade data; generating, by at least one processor, a message comprising data associated with the task of the plurality of tasks associated with the blade; and sending, by at least one processor, the message comprising the data associated with the task of the plurality of tasks associated with the blade to at least one computing device, wherein the at least one computing device is configured to display the message via a display of the at least one computing device.

Clause 16: The method of clause 15, further comprising: determining, by at least one processor, a sharpness of the blade using at least one of: a pressure gauge, a sensor, a calibration device, a pneumatic device, a sonar pulse, and/or any combination thereof.

Clause 17: The method of clause 15 or 16, further comprising: determining, by the at least one processor, whether the sharpness of the blade satisfies a threshold value.

Clause 18: The method of any of clauses 15-17, further comprising: performing the task of the plurality of tasks associated with the blade based on determining that the sharpness of the blade satisfies the threshold value, wherein the task of the plurality of tasks comprises sharpening the blade.

Clause 19: The method of any of clauses 15-18, wherein the blade data comprises a status of the blade, and wherein determining the task of a plurality of tasks associated with the blade based on the blade data comprises: determining that the blade is a defective blade based on the status of the blade.

Clause 20: The method of any of clauses 15-19, further comprising: performing the task of the plurality of tasks associated with the blade based on determining that the blade is a defective blade, wherein the task of the plurality of tasks comprises repairing the blade.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for controlling a blade sharpening and task robot, according to some non-limiting embodiments;

FIG. 2 is a flow diagram of a method for controlling a blade sharpening and task robot, according to some non-limiting embodiments;

FIGS. 3A and 3B are diagrams of a blade sharpening and task robot, according to some non-limiting embodiments;

FIG. 3C is a schematic diagram of example hardware components of the blade sharpening and task robot in FIGS. 3A and 3B, according to some non-limiting embodiments;

FIGS. 4A-4C are diagrams of a blade, according to some non-limiting embodiments;

FIGS. 5A-5C are diagrams of an edge of the blades in FIGS. 4A-4C, according to some non-limiting embodiments;

FIGS. 6A-6E are diagrams of the system of FIG. 1, according to some non-limiting embodiments;

FIGS. 7A-10B are diagrams of determining a sharpness of the blades in FIGS. 4A-4C, according to some non-limiting embodiments; and

FIGS. 11A and 11B are diagrams of a defective blade, according to some non-limiting embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments of the disclosed subject matter. Hence, specific dimensions and other physical characteristics related to the embodiments disclosed herein are not to be considered as limiting.

Some non-limiting embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments, refer to a condition for automatically triggering an action (e.g., a specific operation of an electronic device, such as a computing device, a processor, and/or the like).

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

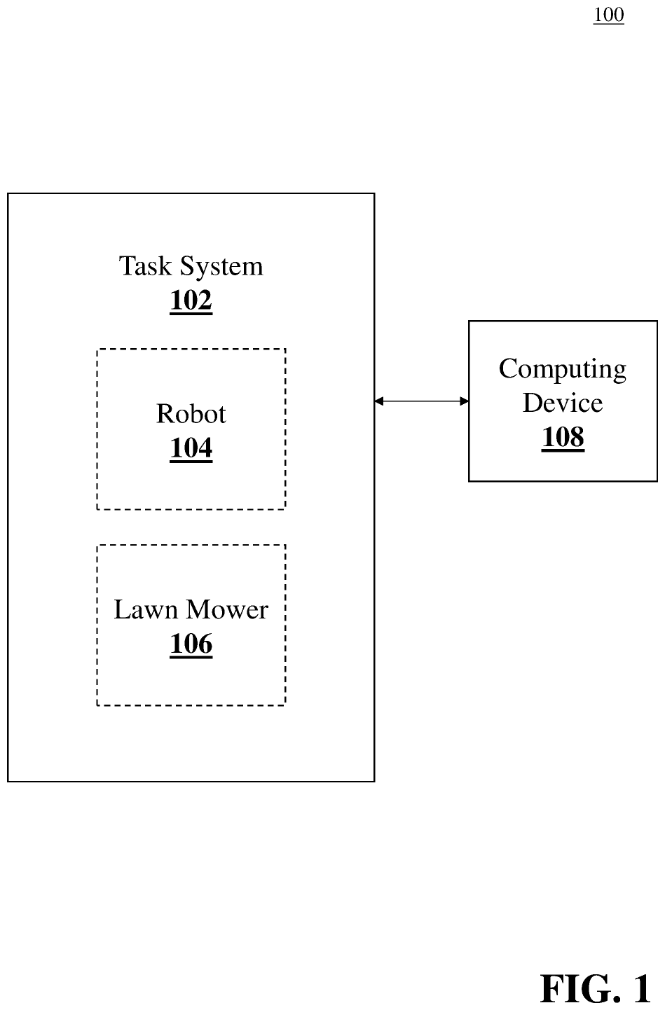

Referring now to FIG. 1, shown is a schematic diagram of a system 100 for a robot configured to orient the robot relative to a lawn mower, according to some non-limiting embodiments. System 100 may include task system 102 and/or computing device 108. Task system 102 and/or computing device 108 may interconnect (e.g., establish a connection to communicate) via wired connections, wireless connections, or a combination of wired and wireless connections.

Task system 102 may include one or more devices configured to communicate with computing device 108. For example, task system 102 may include a server, a group of servers, and/or other like devices. In some non-limiting embodiments, task system 102 may be in communication with a data storage device, which may be local or remote to task system 102. In some non-limiting embodiments, task system 102 may be capable of receiving information from, storing information in, transmitting information to, and/or searching information stored in the data storage device. In some non-limiting embodiments, task system 102 may include lawn mower robot 104 and/or lawn mower 106.

Robot 104 may include a computing device, as described herein. Robot 104 may include one or more devices configured to communicate with computing device 108. In some non-limiting embodiments, robot 104 may be in communication with a data storage device, which may be local or remote to robot 104. In some non-limiting embodiments, robot 104 may be capable of receiving information from, storing information in, transmitting information to, and/or searching information stored in the data storage device. In some non-limiting embodiments, robot 104 may include a blade sharpening and task robot configured to sharpen the blades of lawn mower 106 and/or perform another task associated with lawn mower 106. In some non-limiting embodiments, robot 104 may include an autonomous lawn mower blade sharpening and task apparatus, as described in U.S. Patent Application Publication No. US-2021-0007281-A1, filed on Jul. 14, 2020, the disclosure of which is hereby incorporated by reference in its entirety.

In some non-limiting embodiments, lawn mower 106 may be any type of lawn mower configured to cut grass (e.g., manual push, electric, riding, etc.). In some non-limiting embodiments, lawn mower 106 may include a plurality of components. For example, lawn mower 106 may include a body, a deck, a discharge chute, blades, and/or wheels. In some non-limiting embodiments, lawn mower 106 may include a Radio Frequency Identification (RFID) (e.g., a tag or embedding) which may be scanned and/or read by task system 102, robot 104, and/or computing device 108. In some non-limiting embodiments, the blades of lawn mower 106 may be located on the underside of the body of lawn mower 106.

Computing device 108 may include a computing device configured to communicate with task system 102 (e.g., via a wired or wireless connection). For example, computing device 108 may include a computing device, such as a server, a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments, system 100 may include one or more subsequent computing devices that are the same as, similar to, and/or part of computing device 108.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

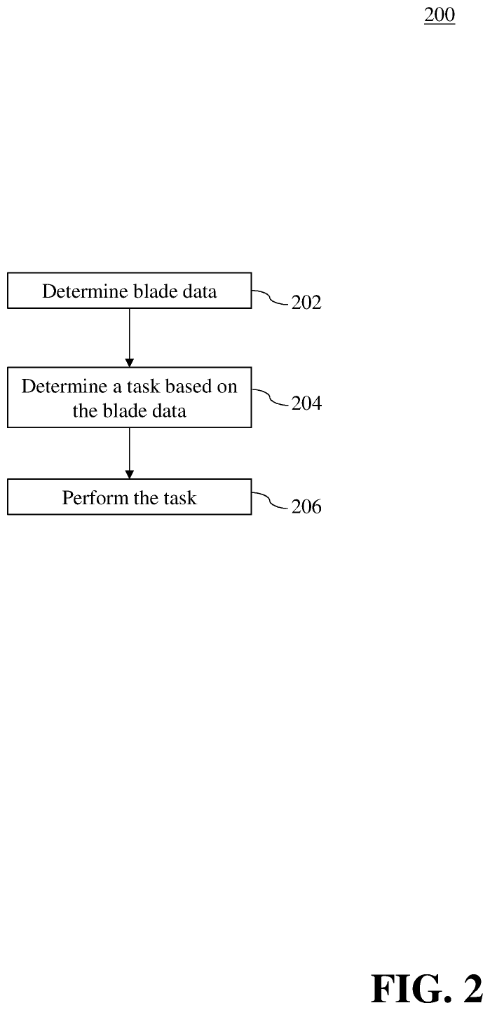

Referring to FIG. 2, shown is a flow diagram of a method 200 for controlling a blade sharpening and task robot, according to some non-limiting embodiments. In some non-limiting embodiments, one or more steps of method 200 may be performed (e.g., completely, partially, etc.) by task system 102 (e.g., one or more devices of task system 102). In some non-limiting embodiments, one or more steps of method 200 may be performed (e.g., completely, partially, etc.) by another device or group of devices separate from task system 102.

In some non-limiting embodiments, task system 102 may receive blade data. For example, task system 102 may receive blade data associated with a blade of lawn mower 106. In some non-limiting embodiments, the blade data may include a plurality of blade features, such as, a dimension of the blade (e.g., a height, width, and depth), a shape of the blade, a type of blade, and/or other features.

In some non-limiting embodiments, task system 102 may control robot 104 to detect and/or capture the blade data. In some non-limiting embodiments, task system 102 may control at least one component of robot 104 to detect and/or capture the blade data. The at least one component of robot 104 may include at least one of: a sensor, a camera, a wavelength device, a mechanical device, and/or measurement device, as described herein.

As shown in FIG. 2, at step 202, method 200 may include determining blade data. For example, task system 102 may determine blade data associated with a blade of lawn mower 106 in response to receiving at least one signal from the at least one component of robot 104.

In some non-limiting embodiments, task system 102 may determine a dimension of the blade. For example, task system 102 may determine a height of the edge of the blade based on receiving the at least one signal from the sensor and/or camera of robot 104. In some non-limiting embodiments, task system 102 may determine a sharpness of the blade based on determining the blade data. For example, task system 102 may determine a sharpness of the blade based on the height of the edge of the blade. Additionally or alternatively, task system 102 may determine the sharpness of the blade based on other features of the blade data.

In some non-limiting embodiments, task system 102 may determine the sharpness of the blade using at least one of a pressure gauge, a sensor, a calibration device, a pneumatic device, a sonar pulse, and/or any combination thereof. For example, robot 104 may include at least one of a pressure gauge, a sensor, a calibration device, a pneumatic device, a sonar pulse, and/or any combination thereof. In some non-limiting embodiments, task system 102 may control robot 104 (e.g., the pressure gauge, the sensor, the calibration device, the pneumatic device, and/or the sonar pulse) to detect and/or capture data associated with the sharpness of the blade. In some non-limiting embodiments, task system 102 may determine the sharpness of the blade based on data and/or a signal received from robot 104.

In some non-limiting embodiments, task system 102 may determine a status of the blade. For example, task system 102 may determine the status of the blade based on the blade data. A status of the blade may be defective (e.g., a defective blade) or non-defective (e.g., a non-defective blade). A blade that is a defective blade may include one or more defects to the blade (e.g., a chip, crack, dent, ding, scrape, bend, etc.).

In some non-limiting embodiments, task system 102 may determine whether the blade is a defective blade based on determining whether the blade includes one or more defects. If the blade includes one or more defects, task system 102 may determine the blade is a defective blade. If the blade does not include at least one defect, task system 102 may determine the blade is a non-defective blade.

In some non-limiting embodiments, task system 102 may determine a health of the blade. For example, task system 102 may determine whether the blade is a healthy blade or an unhealthy blade. Task system 102 may determine the blade is a healthy blade based on the sharpness of the blade and/or based on the status of the blade. If task system 102 determines the sharpness of the blade does not satisfy the threshold value and/or that the status of the blade is non-defective, then task system 102 may determine that the blade is a healthy blade. If task system 102 determines the sharpness of the blade satisfies the threshold value and/or that the status of the blade is defective, then task system 102 may determine that the blade is an unhealthy blade.

In some non-limiting embodiments, task system 102 may determine the sharpness of the blade, the status of the blade, and/or the health of the blade using artificial intelligence (AI), predictive AI, and/or machine learning (e.g., one or more machine learning models). For example, task system 102 may generate, update, and/or maintain a library including language files, image files, and/or video files. In some non-limiting embodiments, task system 102 may generate (e.g., train, validate, re-train, and/or implement) one or more machine learning models, where the one or more machine learning models are trained to provide a prediction. The prediction may include the sharpness of the blade, the status of the blade, and/or the health of the blade.

As shown in FIG. 2, at step 204, method 200 may include determining a task based on the blade data. For example, task system 102 may determine a task of a plurality of tasks based on determining the blade data. In some non-limiting embodiments, the plurality of tasks may include sharpening the blade, repairing the blade, generating a message, and/or sending a message. In some non-limiting embodiments, task system 102 may determine the task of the plurality of tasks based on the sharpness of the blade and/or the status of the blade.

In some non-limiting embodiments, task system 102 may determine the task of the plurality of tasks based on determining whether or not the sharpness of the blade satisfies a threshold value. For example, task system 102 may determine that the task includes sharpening the blade based on determining that the sharpness of the blade satisfies the threshold value. In some non-limiting embodiments, task system 102 may determine that the task does not include sharpening the blade based on determining that the sharpness of the blade does not satisfy the threshold value.

In some non-limiting embodiments, the threshold value may be a predetermined threshold value. For example, the threshold value may include a range of a height of the edge of the blade (e.g., 0.030 inches-0.045 inches). In some non-limiting embodiments, task system 102 may include (e.g., store in a memory of task system 102) a database including a plurality of threshold values corresponding to a plurality of blades. In some non-limiting embodiments, task system 102 may query the database to determine a threshold value corresponding to the blade based on the blade data.

In some non-limiting embodiments, task system 102 may determine whether the blade is a defective blade. For example, task system 102 may determine whether the blade is a defective blade based on the status of the blade. In some non-limiting embodiments, task system 102 may determine the task of the plurality of tasks based on determining whether the blade is a defective blade. For example, task system 102 may determine the task of the plurality of tasks includes repairing the blade based on determining the blade is a defective blade. In some non-limiting embodiments, when determining whether the blade is a defective blade, task system 102 may determine whether the blade includes a defect. The defect may include a chip, a scratch, a bend, and/or any combination thereof.

In some non-limiting embodiments, task system 102 may generate a message including data associated with the task of the plurality of tasks associated with the blade. For example, task system 102 may generate a message including the task, details associated with the task (e.g., a location of the task relative to robot 104, a location of the task relative to lawn mower 106, a time to complete the task, steps required to complete the task, and/or any combination thereof).

In some non-limiting embodiments, task system 102 may send the message comprising the data associated with the task to at least one computing device. For example, task system 102 may send the message comprising the data associated with the task to computing device 108. Computing device may be configured to display the message via a display of computing device 108. In some non-limiting embodiments, the at least one computing device may be configured to perform the task.

In some non-limiting embodiments, task system 102 may send the message comprising the data associated with the task to robot 104. In some non-limiting embodiments, robot 104 may be configured to display the message. For example, robot 104 may display the message via a display of robot 104 in response to receiving the message. In some non-limiting embodiments, robot 104 may be configured to perform the task. For example, robot 104 may be configured to perform the task in response to receiving the message.

As shown in FIG. 2, at step 206, method 200 may include performing the task. For example, task system 102 may perform the task based on determining the task of the plurality of tasks. In some non-limiting embodiments, task system 102 may perform the task before or after generating and/or sending the message.

In some non-limiting embodiments, task system 102 may perform the task in response to receiving a second message from at least one computing device. The second message may include instructions instructing task system 102 to perform the task.

In some non-limiting embodiments, task system 102 may control robot 104 to perform the task of the plurality of tasks. For example, task system 102 may control at least one task arm of robot 104 to perform the task of the plurality of tasks. For example, task system 102 may control the at least one task arm of robot 104 to sharpen the blade and/or repair the blade. Task system 102 may control the at least one task arm to sharpen the blade based on determining that the sharpness of the blade satisfies the threshold value. Task system 102 may control the at least one task arm of robot 104 to repair the blade based on determining that the blade is a defective blade.

In some non-limiting embodiments, task system 102 may determine and/or perform one or more tasks of the plurality of tasks. In some non-limiting embodiments, when performing a plurality of tasks, task system 102 may determine an order of the plurality of tasks and perform the plurality of tasks based on the order.

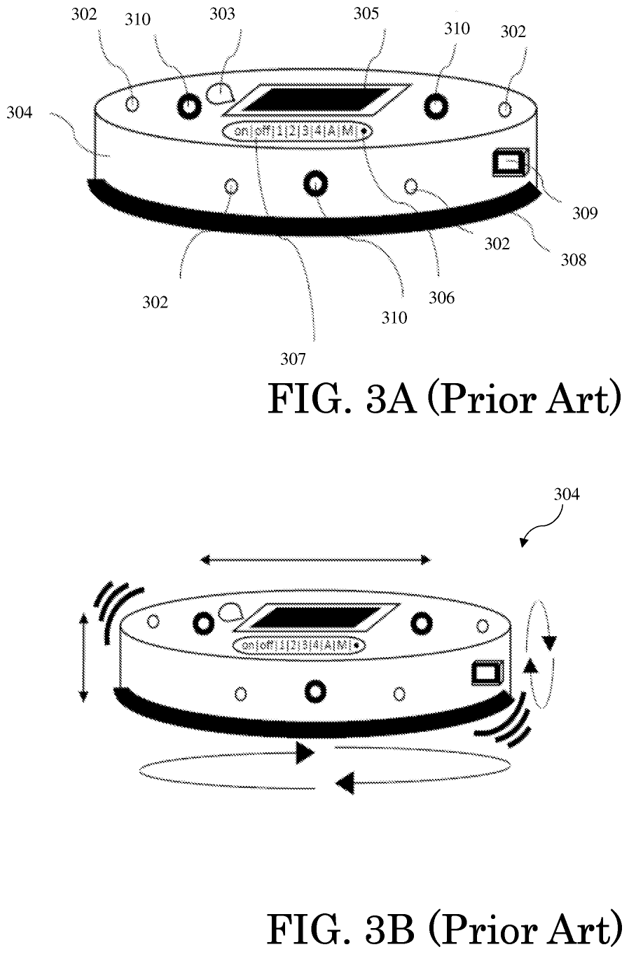

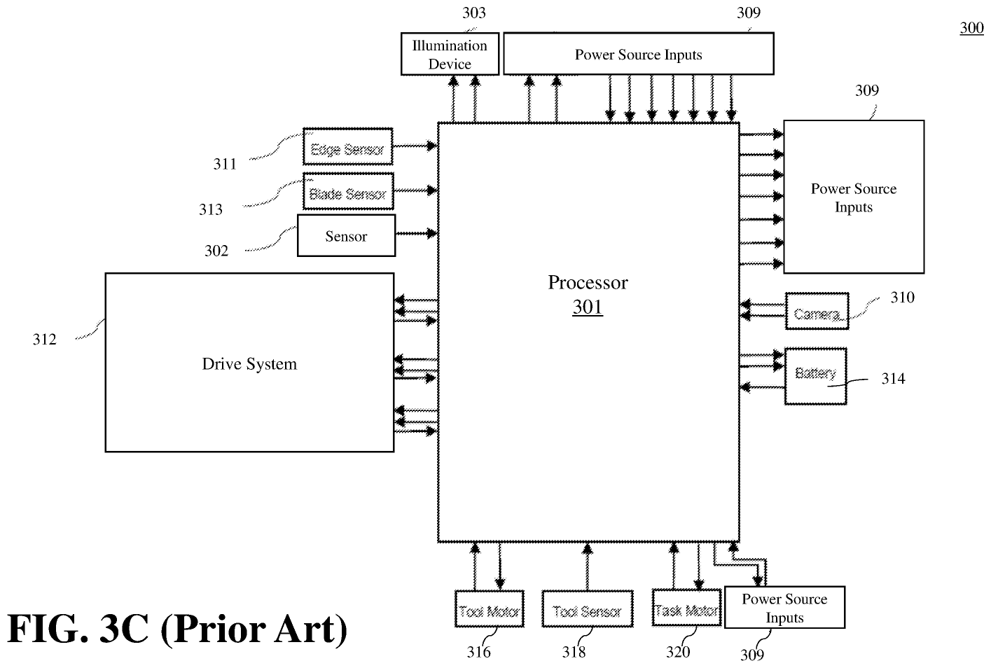

FIGS. 3A and 3B are diagrams of robot 304, according to some non-limiting embodiments. In some non-limiting embodiments, robot 304 may be the same as, similar to, and/or part of robot 104. In some non-limiting embodiments, robot 304 may include a plurality of components. In some non-limiting embodiments, the plurality of components may be operatively connected to at least one processor. In some non-limiting embodiments, the plurality of components may be configured to receive data from and/or communicate data to the at least one processor. In some non-limiting embodiments, the plurality of components of robot 304 may include sensor 302, illumination device 303, base 305, indicator 306, panel 307, duster 308, and power source input 309, and/or at least one camera 310.

In some non-limiting embodiments, sensor 302 may include one or more sensors. The one or more sensors may include light detection and ranging (LiDAR) sensor(s), time-of-flight (ToF) sensor(s), proximity sensor(s), optical sensor(s), image sensor(s), or any combination thereof. In some non-limiting embodiments, sensor 302 may detect at least one signal. For example, sensor 302 may be configured to detect at least one signal associated with at least one component of a plurality of components of lawn mower 106. In some non-limiting embodiments, sensor 302 may be operatively connected to at least one processor. In some non-limiting embodiments, sensor 302 may be configured to communicate the at least one signal to the at least one processor.

In some non-limiting embodiments, illumination device 303 may include a light (e.g., an LED light) and/or a speaker. Illumination device 303 may be configured to generate, transmit, and/or receive data (e.g., visualization, voice commands, and/or loud noise response). For example there is a loud noise, such as lawn mower 106 starting up or running, the robot 304 may be configured to autonomously drive away from lawn mower 106.

In some non-limiting embodiments, base 305 may include a task tool (e.g., a task arm) and/or solar panel. In some non-limiting embodiments, base 305 may be replaceable, modular, motorized, and/or static. In some non-limiting embodiments, base 305 may include a depression configured to catch any falling debris, thereby providing for easy cleaning and less debris spread, as well as a location to store task tools and task tips not in use.

In some non-limiting embodiments, indicator 306 may include an LED light. Indicator 306 may be configured to light up to indicate various possible features of the robot 304, such as, e.g., robot power, program(s), settings, task input, and/or mode.

In some non-limiting embodiments, panel 307 may include buttons, battery power, signal strength, dials, and/or other indications which will provide various options for programs, settings, on/off, LED, and/or user inputs.

In some non-limiting embodiments, duster 308 may be configured to capture and/or move debris. Duster 308 may be configured to push debris out of the path of the robot 304 in order to keep it from becoming caught, traveling under, or otherwise inhibiting the progress of the robot 304 in all directions.

In some non-limiting embodiments, power source input 309 may be configured for use with one or more of power cables, USB cables, cable input sources, device receivers, remote receivers, external device receivers, and/or other cables to otherwise control or program robot 304 externally, wirelessly, and/or controlled by an owner/user.

In some non-limiting embodiments, camera 310 may be configured to perform an optimal alignment of task arm(s) and/or task tip(s) for precision accuracy in task(s). In some non-limiting embodiments, camera 310 may be configured to capture object data associated with a plurality of components of lawn mower 106. For example, the at least one processor may control camera 310 to capture object data associated with a plurality of components of lawn mower 106.

In some non-limiting embodiments, robot 304 may include components which may or may not be round and/or square and/or oval and/or a geometric shape and/or any shape and/or any color and/or any material and/or any height and/or any width and/or any circumference. Specifically, referring to FIG. 3A, robot 304 is shown as viewed in a normal state. Robot 304 may be formed by various shapes, sizes, colors, weights, heights, widths, and/or design.

In some non-limiting embodiments, robot 304 may include drive system 312 (shown in FIG. 3C). In some non-limiting embodiments the drive system may include one or more motors, wheels, balls, tracks, and/or any combination thereof. The drive system may include at least one brake and/or actuator. The brake and/or actuator may be configured to steer, stop, elevate, and/or descend robot 304. In some non-limiting embodiments, the brake and/or actuator may cause robot 304 to lock into place, pivot, counter act vibration (e.g., anti-vibration), and/or counter-balance.

In some non-limiting embodiments, wheels may be provided for the purposes of moving the robot in any direction at a speed. In some non-limiting embodiments, the speed may be controlled by programming, a device, and/or set by a user. Alternatively, one or more tracks may be utilized in lieu of, or in addition to, the wheels. Alternatively, a ball or track may be used in place the wheels.

As shown in FIG. 3B, robot 304 may move in any direction (e.g., front, back, diagonally, side-to-side) and/or rotate (e.g., 360 degrees). In some non-limiting embodiments, robot 304 may move around and/or encircle an object (e.g., a lawn mower 106).

In some non-limiting embodiments, robot 304 may be configured to move from a first location to a second location. In some non-limiting embodiments, robot 304 may be configured to move between, under, and/or around one or more lawn mowers.

Referring now to FIG. 3C, shown is a schematic diagram of example hardware components of robot 304, according to some non-limiting embodiments. In some non-limiting embodiments, robot 304 may include at least one processor 301. In some non-limiting embodiments, processor 301 may include an 8-bit processor. In some non-limiting embodiments, one or more components of robot 304 may include at least one second processor (not shown).

In some non-limiting embodiments, robot 304 may include one or more sensors. For example, robot 304 may include sensor 302, edge sensor 311, blade sensor 313, and/or tool sensor 318. In some non-limiting embodiments, processor 301 may be operatively connected to the one or more sensors. For example, processor 301 may be operatively connected to and/or control at least one of sensor 302, edge sensor 311, blade sensor 313, and/or tool sensor 318. In some non-limiting embodiments, at least one of sensor 302, edge sensor 311, blade sensor 313, and/or tool sensor 318 may include light detection and ranging (LIDAR) device(s), object detection system(s), Time-of-Flight (ToF) sensor(s), and/or other various sensor(s), lasers, and/or various other approximation and/or detection apparatuses, and/or any combination thereof.

Processor 301 may be operatively connected to one or more systems or devices. For example, processor 301 may be operatively connected to and/or control illumination device 303, camera 310, drive system 312 (e.g., one or more components of drive system 312), battery 314, tool motor 316, and/or ask motor 320.

Processor 301 may be operatively connected to one or more power source inputs 309 (e.g., Power LED, User Button, User Button LEDs, and USB). In some non-limiting embodiments, power source input 309 may be configured to connect to: power cables, USB cables, other cable input sources, device receivers, remote receivers, external device receivers, and/or other cables to otherwise control or program the robot externally, wirelessly, and/or controlled by an owner.

In some non-limiting embodiments, drive system 312 may be configured to move the robot in any direction at a speed controlled by programming, device, owner, and/or settings. One or more wheels, balls, and/or tracks may be provided to assist in the steering and mobile refinement for lining up robot 304 for tasks in an accurate fashion and/or general motion purposes.

In some non-limiting embodiments, edge sensor 311 may be connected to at least one task tip (not shown) of robot 304. In some non-limiting embodiments, the task tip may be integrated into the task arm, replaceable from the task arm, removable from the task arm, modular in relation to the task arm able to accommodate multiple different and/or similar task tips as a single tip and/or multiple tips at the same time and/or in conjunction with each other.

Further details regarding robot 304 (e.g., a lawn mower blade sharpening and task apparatus) are described in U.S. Patent Application Publication No. US-2021-0007281-A1, filed on Jul. 14, 2020, the disclosure of which is hereby incorporated by reference in its entirety.

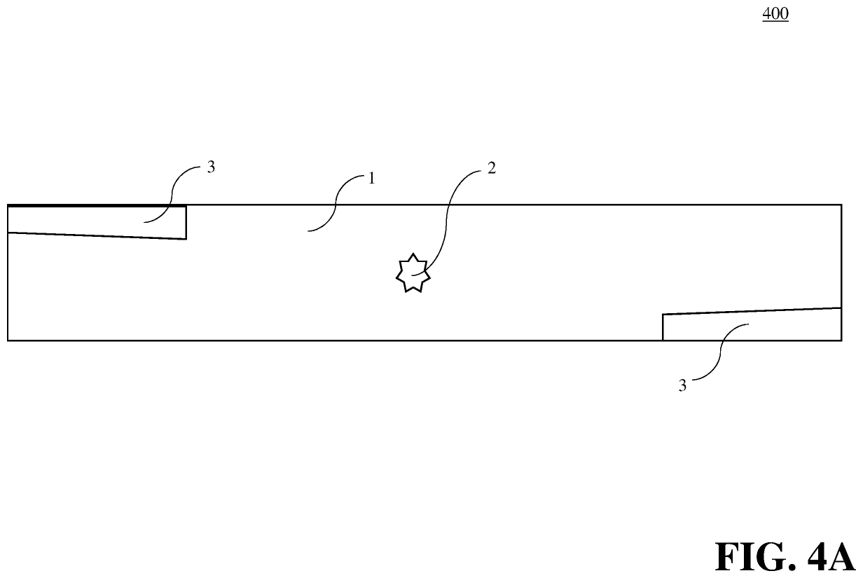

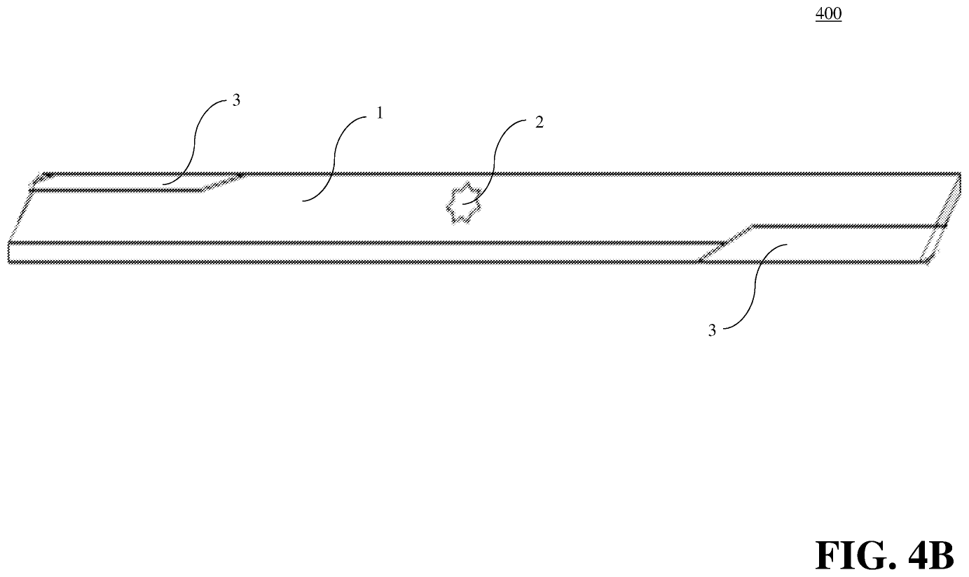

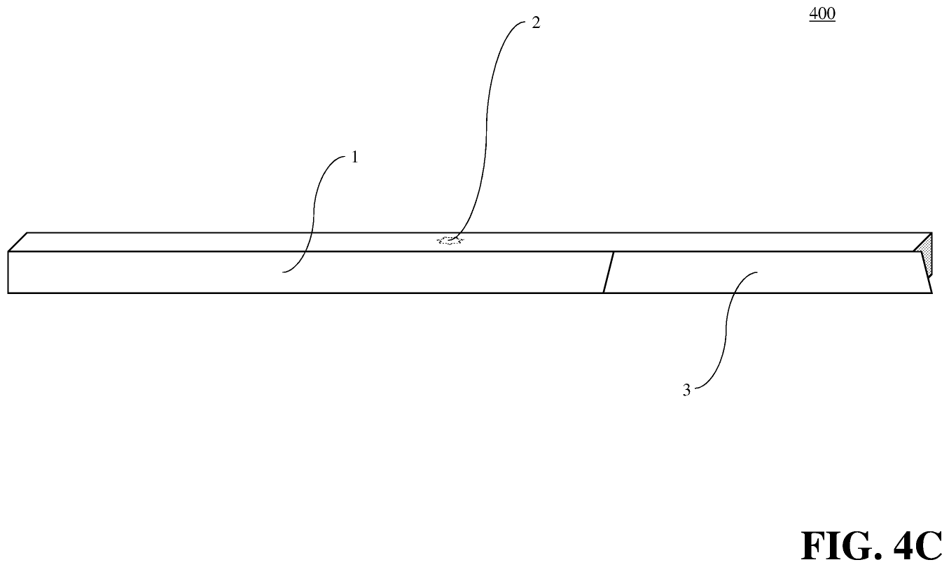

Referring now to FIGS. 4A-4C, shown are diagrams of a blade 400, according to some non-limiting embodiments. In some non-limiting embodiments, blade 400 may be attached or detached to lawn mower 106. For example, blade 400 may be attached to a bottom side of lawn mower 106. Alternatively, blade 400 may be detached from lawn mower 106 and configured to be attached to lawn mower 106 via any device configured to attach a blade to a lawn mower (e.g., a screw).

In some non-limiting embodiments, blade 400 may include body 1, hole 2, and/or edge 3. In some non-limiting embodiments, body 1 may include two ends (e.g., a first end and a second end) and/or six sides (e.g., a top side, a bottom side, a front side, a bottom side, a left side, and a right side). The first end may be located at a first side of the six sides and the second end may be located at a second side of the six sides. In some non-limiting embodiments, body 1 may include hole 2 and/or edge 3.

In some non-limiting embodiments, hole 2 may be configured to attach blade 400 to lawn mower 106. For example, hole 2 may include a slot configured to join blade 400 to lawn mower 106. In some non-limiting embodiments, hole 2 may be smooth. Alternatively, hole 2 may include threading, which may be configured to receive a screw to attach blade 400 to lawn mower 106. Hole 2 may be a shape (e.g., a circle, oval, star, rectangle, square, etc.).

In some non-limiting embodiments, blade 400 may include one or more edges 3. For example, blade 400 may include a first edge 3 and/or a second edge 3. For example, blade 400 may include a first edge located at a location of a first side of blade 400 and/or a second edge located at a location of a second side of blade 400, as shown in FIGS. 4A and 4B.

Edge 3 may include a v-edge, a compound bevel edge, a convex edge, a hollow edge, and/or chisel edge. In some non-limiting embodiments, edge 3 may include at least one cutting edge (e.g., an edge configured to cut a blade of grass). The cutting edge may include an apex cutting edge of blade 400. In some non-limiting embodiments, the sharpness of blade 400 may be determined based on a height of edge 3 (e.g., a height of the blade cutting edge).

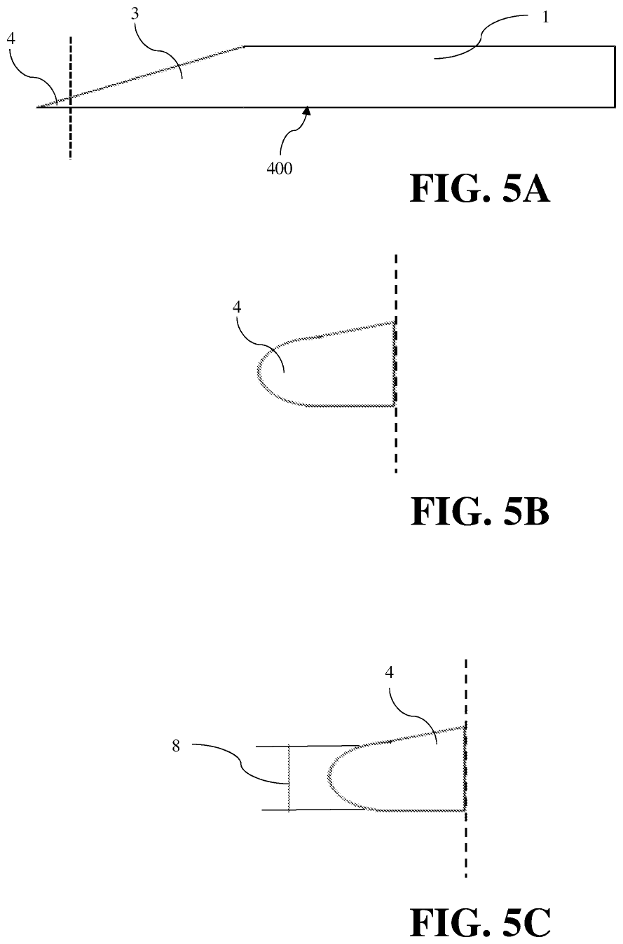

Referring now to FIGS. 5A-5C, shown are diagrams of an edge 3 of the blade 400, according to some non-limiting embodiments. As shown in FIG. 5A, edge 3 may include leading cutting edge 4. For example, the at least one cutting edge may include leading cutting edge 4. Leading cutting edge 4 may be located at the first end and/or a second end of blade 400. In some non-limiting embodiments, the sharpness of blade 400 may be determined based on a height of leading cutting edge 4 (e.g., a height of the blade cutting edge).

FIGS. 5B and 5C show a cross-sectional view of leading cutting edge 4. As shown in FIG. 5C, leading cutting edge 4 may include height 8. In some non-limiting embodiments, a sharpness of blade 400 may be determined based on height 8. For example, task system 102 may measure (e.g., using the at least one sensor) height 8 of leading cutting edge 4 of blade 400 to determine a sharpness of blade 400.

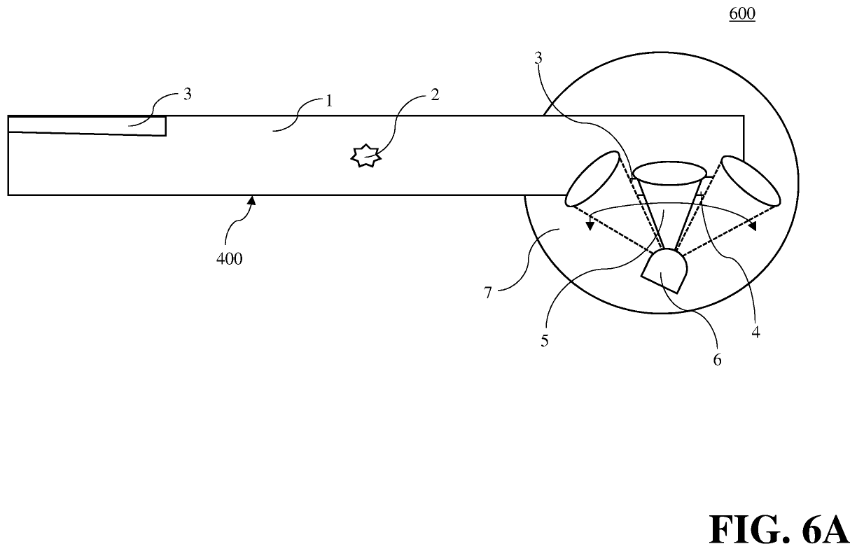

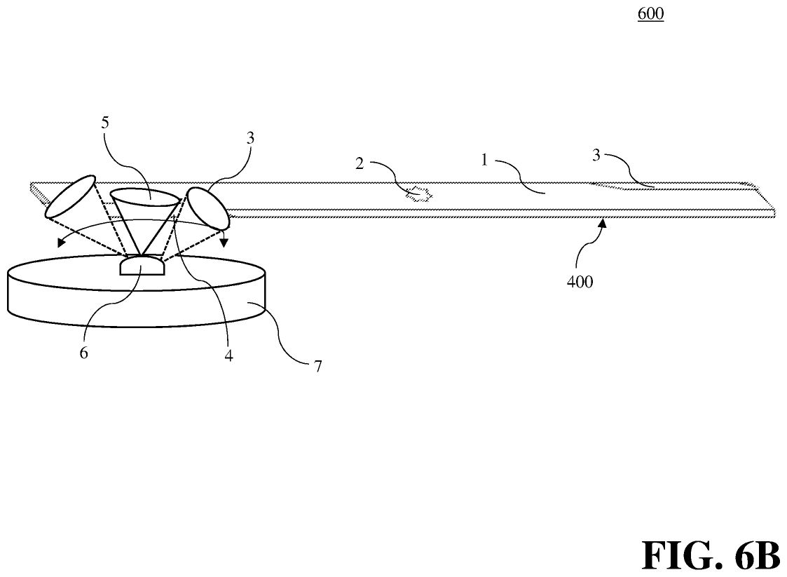

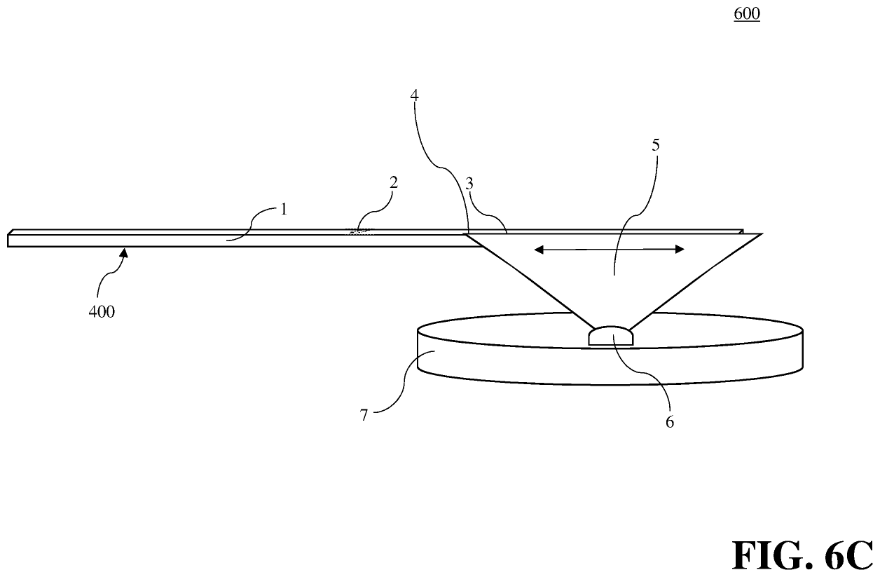

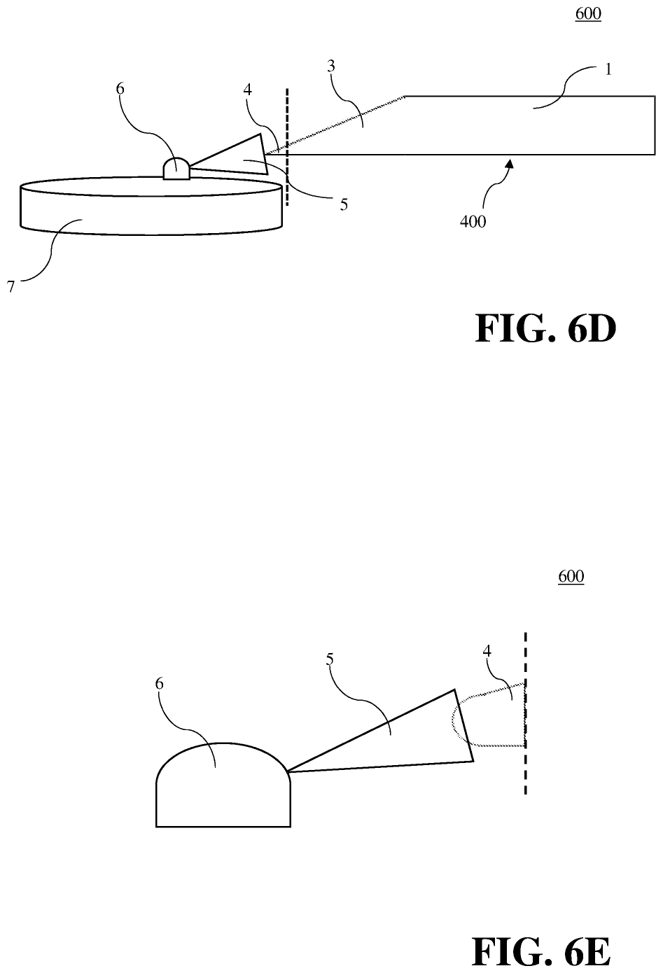

Referring now to FIGS. 6A-6E, shown are diagrams of a system 600 for controlling a blade sharpening and task robot, according to some non-limiting embodiments. In some non-limiting embodiments, system 600 may include blade 400 and robot 7. In some non-limiting embodiments, robot 7 may be the same as, similar to, and/or part of robot 104 and/or robot 304.

In some non-limiting embodiments, robot 7 may include at least one device 6. Device 6 may include one or more of the plurality of components of the robot, as described herein. For example, device 6 may include at least one sensor and/or at least one camera, as described herein.

Device 6 may be operatively connected to at least one processor of robot 7 (e.g., processor 301). For example, processor 301 may be configured to control device 6. In some non-limiting embodiments, device 6 may be configured to scan, detect, and/or capture at least one signal 5 associated with blade 400. For example, the at least one processor of robot 7 may control device 6 to scan, detect, and/or capture at least one signal 5 associated with blade 400.

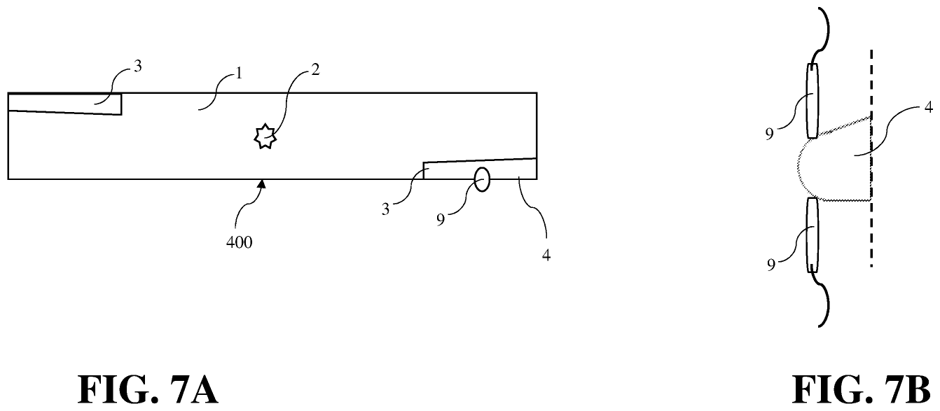

FIGS. 7A-10B are diagrams of determining a sharpness of blade 400, according to some non-limiting embodiments.

In some non-limiting embodiments, task system 102 may include sensor 9, wavelength device 10, mechanical device 11, sharpening device 12, and/or measurement device 13. In some non-limiting embodiments, robot 104 and/or lawn mower 106 may include at least one of sensor 9, wavelength device 10, mechanical device 11, sharpening device 12, measurement device 13, chip 14, and/or any combination thereof. In some non-limiting embodiments, task system 102 may control sensor 9, wavelength device 10, mechanical device 11, sharpening device 12, and/or measurement device 13.

Sensor 9 may include a sensor, a pressure gauge, a tactile device, and/or a mechanical device. As shown in FIG. 7A and 7B, task system 102 may control sensor 9 to determine the threshold value of blade 400, as described herein. As shown in FIG. 7B, sensor 9 may detect and/or capture blade data associated with blade 400. In some non-limiting embodiments, sensor 9 may detect and/or capture blade data used (e.g., by task system 102) to determine a sharpness of blade 400. For example, sensor 9 may be configured to detect and/or capture blade data at a location of leading cutting edge 4 of blade 400. In some non-limiting embodiments, task system 102 may determine a threshold value of blade 400 based at least partially on the blade data received from sensor 9. In some non-limiting embodiments, task system 102 may compare the blade data received from sensor 9 to the threshold value to determine whether the sharpness of blade 400 satisfies the threshold value, as described herein.

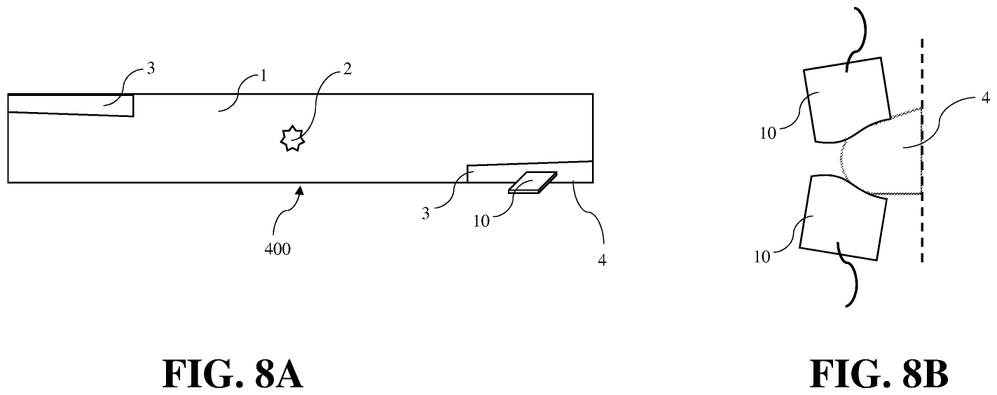

Wavelength device 10 may include a sonar wavelength device, a pulse wavelength device, and/or any other type of wavelength device. As shown in FIGS. 8A and 8B, task system 102 may control wavelength device 10 to determine the threshold value of blade 400, as described herein. As shown in FIG. 8B, wavelength device 10 may be configured to detect and/or capture blade data associated with blade 400. In some non-limiting embodiments, wavelength device 10 may detect and/or capture blade data used (e.g., by task system 102) to determine a sharpness of blade 400. For example, wavelength device 10 may detect and/or capture blade data at a location of leading cutting edge 4 of blade 400. In some non-limiting embodiments, task system 102 may determine a threshold value of blade 400 based at least partially on the blade data received from wavelength device 10. In some non-limiting embodiments, task system 102 may compare the blade data received from wavelength device 10 to the threshold value to determine whether the sharpness of blade 400 satisfies the threshold value, as described herein.

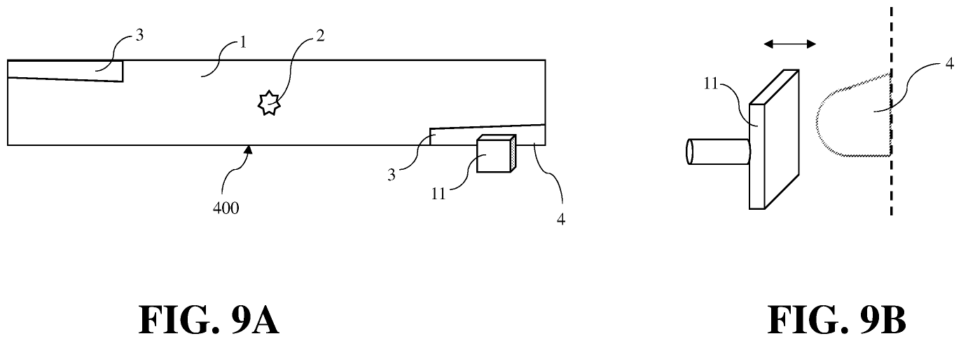

Mechanical device 11 may include a pneumatic pad, a tactile pad, and/or any other mechanical device. As shown in FIGS. 9A and 9B, task system 102 may control mechanical device 11 to determine the threshold value of blade 400, as described herein. As shown in FIG. 9B, mechanical device 11 may be configured to detect and/or capture blade data associated with blade 400. In some non-limiting embodiments, mechanical device 11 may detect and/or capture blade data used (e.g., by task system 102) to determine a sharpness of blade 400. For example, mechanical device 11 may detect and/or capture blade data at a location of leading cutting edge 4 of blade 400. In some non-limiting embodiments, task system 102 may determine a threshold value of blade 400 based at least partially on the blade data received from mechanical device 11. In some non-limiting embodiments, task system 102 may compare the blade data received from mechanical device 11 to the threshold value to determine whether the sharpness of blade 400 satisfies the threshold value, as described herein.

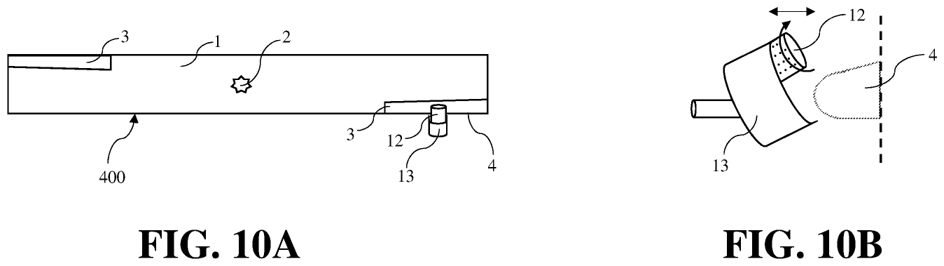

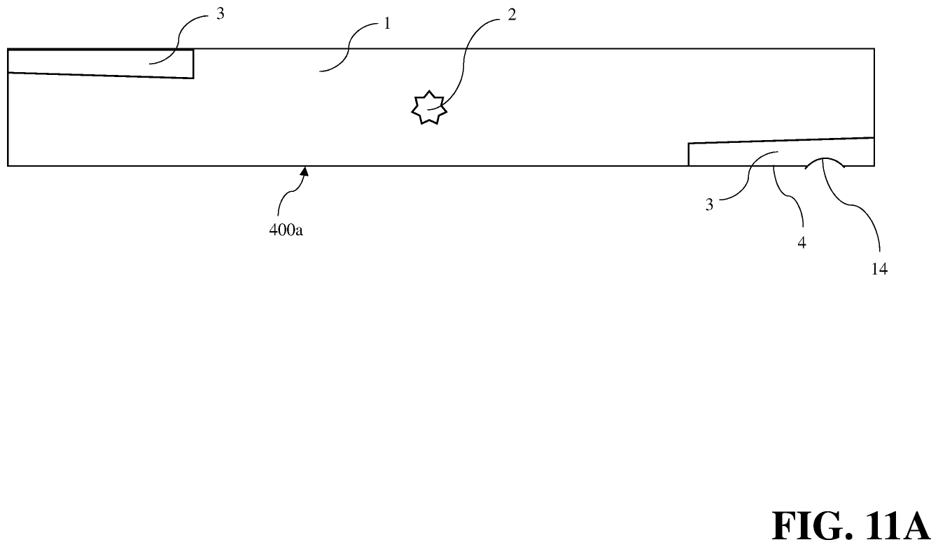

Sharpening device 12 may include a drum and/or any other sharpening device. In some non-limiting embodiments, sharpening device 12 may include measurement device 13. Alternatively, sharpening device 12 may be attached to measurement device 13. In some non-limiting embodiments, sharpening device 12 may be configured to sharpen blade 400. For example, as shown in FIGS. 10A and 10B, sharpening device 12 may be configured to sharpen leading cutting edge 4 of blade 400. Sharpening device 12 may be configured to rotate (e.g., 360 degrees) and/or move in back and forth (e.g., in a horizontal direction) about leading cutting edge 4 to sharpen leading cutting edge 4. In some non-limiting embodiments, task system 102 may control sharpening device 12 to sharpen leading cutting edge 4.

Measurement device 13 may be configured to measure blade 400. For example, measurement device 13 may be configured to measure leading cutting edge 4 of blade 400. In some non-limiting embodiments, task system 102 may control measurement device 13 to measure leading cutting edge 4.

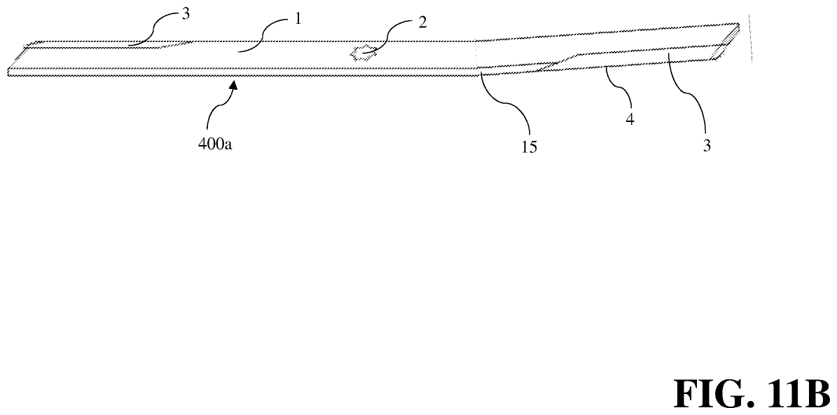

Referring now to FIGS. 11A and 11B, shown are diagrams of a defective blade 400a, according to some non-limiting embodiments. As shown in FIGS. 11A and 11B, defective blade 400a may include one or more defects. The one or more defects may include chip 14, bend 15, and/or any combination thereof.

Chip 14 may include a crack in blade 400a and/or a portion missing from blade 400a. Bend 15 may include a bend and/or a distortion to a shape of blade 400a.

In some non-limiting embodiments, task system 102 may determine the status of blade 400. For example, task system 102 may determine the status of blade 400 based on determining whether or not blade 400 includes one or more defects. Task system 102 may determine whether blade 400 includes one or more defects based on receiving at least one signal (e.g., from robot 104). A status of blade 400 may include a defective blade or a non-defective blade.

In some non-limiting embodiments, task system 102 may determine blade 400 is a defective blade based on determining blade 400 includes chip 14, bend 15, and/or any combination thereof. Task system 102 may determine blade 400 is a non-defective blade based on determining blade 400 does not include chip 14 and/or bend 15.

In some non-limiting embodiments, task system 102 may determine the task of the plurality of tasks includes repairing the blade based on determining the blade is a defective blade. In some non-limiting embodiments, task system 102 may be configured to repair blade 400. In some non-limiting embodiments, robot 104 may be configured to repair blade 400. For example, the at least one task arm of robot 104 may be configured to repair (e.g., smooth and/or fill in chip 14 and/or un-bend bend 15). In some non-limiting embodiments, task system 102 may control the at least one task arm of robot 104 to repair blade 400 based on determining blade 400 is a defective blade.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system, comprising:
at least one processor configured to:
receive blade data, the blade data associated with a blade of a lawn mower;
determine a task of a plurality of tasks associated with the blade of the lawn mower based on the blade data;
generate a message comprising data associated with the task of the plurality of tasks associated with the blade; and
send the message comprising the data associated with the task of the plurality of tasks associated with the blade to at least one computing device, wherein the at least one computing device is configured to display the message via a display of the at least one computing device.

2. The system of claim 1, wherein the at least one processor is configured to:
determine the sharpness of the blade using at least one of: a pressure gauge, a sensor, a calibration device, a pneumatic device, a sonar pulse, and/or any combination thereof.

3. The system of claim 2, wherein the at least one processor is further configured to:
determine whether the sharpness of the blade satisfies a threshold value.

4. The system of claim 3, wherein the task of the plurality of tasks comprises sharpening the blade, and wherein, based on determining that the sharpness of the blade satisfies the threshold value, the at least one processor is configured to:
perform the task of the plurality of tasks associated with the blade.

5. The system of claim 1, wherein the blade data comprises a sharpness of the blade, and wherein, when determining the task of a plurality of tasks associated with the blade based on the blade data, the at least one processor is configured to:
determine the task of a plurality of tasks associated with the blade based on the sharpness of the blade.

6. The system of claim 1, wherein the blade data comprises a status of the blade, and wherein, when determining the task of a plurality of tasks associated with the blade based on the blade data, the at least one processor is configured to:
determine whether the blade is a defective blade based on the status of the blade; and
determine the task of the plurality of tasks associated with the blade based on determining the blade is a defective blade.

7. The system of claim 1, wherein the at least one computing device is a robot, and wherein the robot is configured to perform the task of the plurality of tasks based on receiving the message comprising the data associated with the task of the plurality of tasks associated with the blade.

8. A system, comprising:
at least one sensor;
at least one task arm; and
at least one processor operatively connected to the at least one sensor and the at least one task arm, the at least one processor configured to:
determine blade data associated with a blade of a lawn mower based on a signal received from the at least one sensor;
determine a task of a plurality of tasks associated with the blade based on the blade data; and
control the at least one task arm to perform the task of the plurality of tasks associated with the blade.

9. The system of claim 8, wherein the at least one processor is further configured to:
determine a sharpness of the blade based on a second signal received from the at least one sensor.

10. The system of claim 9, wherein, when controlling the at least one task arm to perform the task of the plurality of tasks associated with the blade, the at least one processor is configured to:
determine whether the sharpness of the blade satisfies a threshold value; and
control the at least one task arm to sharpen the blade of the lawn mower, based on determining that the sharpness of the blade satisfies the threshold value.

11. The system of claim 8, wherein the at least one processor is further configured to:
generate a message comprising data associated with the task of the plurality of tasks associated with the blade; and
send the message comprising the data associated with the task of the plurality of tasks associated with the blade to at least one computing device, wherein the at least one computing device is configured to display the message via a display of the at least one computing device.

12. The system of claim 8, wherein the blade data comprises a status of the blade, and wherein, when determining the task of a plurality of tasks associated with the blade based on the blade data, the at least one processor is configured to:
determine whether the blade is a defective blade based on the status of the blade.

13. The system of claim 12, wherein the at least one processor is configured to:
control the at least one task arm to repair the blade based on determining the blade is a defective blade.

14. The system of claim 7, wherein the at least one computing device is a robot, and wherein the robot is configured to perform the task of the plurality of tasks based on receiving the message.

15. A method, comprising:
receiving, by at least one processor, blade data associated with a blade of a lawn mower;
determining, by at least one processor, a task of a plurality of tasks associated with the blade based on the blade data;
generating, by at least one processor, a message comprising data associated with the task of the plurality of tasks associated with the blade; and
sending, by at least one processor, the message comprising the data associated with the task of the plurality of tasks associated with the blade to at least one computing device, wherein the at least one computing device is configured to display the message via a display of the at least one computing device.

16. The method of claim 15, further comprising:
determining, by at least one processor, a sharpness of the blade using at least one of: a pressure gauge, a sensor, a calibration device, a pneumatic device, a sonar pulse, and/or any combination thereof.

17. The method of claim 16, further comprising:
determining, by the at least one processor, whether the sharpness of the blade satisfies a threshold value.

18. The method of claim 17, further comprising:
performing the task of the plurality of tasks associated with the blade based on determining that the sharpness of the blade satisfies the threshold value, wherein the task of the plurality of tasks comprises sharpening the blade.

19. The method of claim 15, wherein the blade data comprises a status of the blade, and wherein determining the task of a plurality of tasks associated with the blade based on the blade data comprises:
determining that the blade is a defective blade based on the status of the blade.

20. The method of claim 19, further comprising:
performing the task of the plurality of tasks associated with the blade based on determining that the blade is a defective blade, wherein the task of the plurality of tasks comprises repairing the blade.
